(19) United States
(12) Patent Application Publication
(10) Pub. No.: US 2024/0301304 A1
(43) Pub. Date: Sep. 12, 2024

(54) METHOD AND APPARATUS FOR PRODUCING HYDROGEN

(71) Applicant: HiTES Holding GmbH, Sulzbach-Rosenberg (DE)

(72) Inventor: Dragan Stevanovic, Sulzbach-Rosenberg (DE)

(21) Appl. No.: 18/666,186

(22) Filed: May 16, 2024

Related U.S. Application Data
(63) Continuation-in-part of application No. PCT/EP2022/081912, filed on Nov. 15, 2022.
(63) Continuation-in-part of application No. PCT/EP2022/081925, filed on Nov. 15, 2022.
(63) Continuation-in-part of application No. PCT/EP2022/081943, filed on Nov. 15, 2022.

(30) Foreign Application Priority Data
Nov. 16, 2021 (DE) 102021129804.0
Nov. 16, 2021 (DE) 102021129810.5
Nov. 16, 2021 (DE) 102021129812.1

(51) Int. Cl. C10J 3/28; C01B 3/50; C10J 3/04; C10J 3/14; C10J 3/16; C10J 3/72; C10J 3/86; C10K 1/00; C10K 1/02; C10K 1/04; C10K 1/20

(52) U.S. Cl. CPC C10J 3/28; C01B 3/508; C10J 3/04; C10J 3/14; C10J 3/16; C10J 3/723; C10J 3/86; C10K 1/002; C10K 1/024; C10K 1/046; C10K 1/20; C10J 2300/0916; C10J 2300/0976; C10J 2300/1253; C10J 2300/1603; C10J 2300/1687; C10J 2300/1838; C10J 2300/1892

(57) ABSTRACT

A method for converting carbonaceous raw materials and in particular biomass into hydrogen, includes the steps of: gasification of the carbon-containing raw materials in a gasifier, wherein heated water vapour is introduced into the gasifier and used for gasification; and cleaning of the hydrogen-containing synthesis gas produced in the gasification, wherein the gasification is an allothermal gasification and the heated water vapour is used both as gasification agent and as heat carrier for the gasification, wherein energy not used for H2 production is at least partially reused for the production and/or superheating of water vapour.

### CROSS REFERENCE TO RELATED APPLICATIONS

The subject application is a continuation-in-part of PCT International Patent Application Serial Nos. and PCT/EP2022/081943, filed Nov. 15, 2022; PCT/EP2022/081925, filed Nov. 15, 2022; and PCT/EP2022/081912, filed Nov. 15, 2022, which claim priority from German Patent Application Serial Nos. 102021129812.1, filed Nov. 16, 2021; 102021129810.5, filed Nov. 16, 2021; and 102021129804.0, filed Nov. 16, 2021, the contents of which are incorporated herein.

### BACKGROUND OF THE INVENTION

The present invention relates to an apparatus and a method for producing hydrogen.

It has long been recognised that hydrogen is a very important future energy source that can and will make a decisive contribution to the energy transition. It is therefore very important that the hydrogen produced is CO₂-neutral, which is nowadays referred to as “green” or “blue” or “turquoise”. The majority (well over 90%) of hydrogen on the market is “grey”, obtained from fossil primary energy sources with accompanying CO₂ emissions, and for this reason it cannot contribute to the energy transition. The use of biomass for the present invention is a further step towards changing this current situation.

### STATE OF THE ART

The oldest production of large quantities of hydrogen is based on coal gasification with water vapour (water-gas reaction) by means of a chemical reaction:

C+H₂O→CO+H₂

Today, the most important method for hydrogen production is steam reforming, wherein the methane from natural gas reacts with the steam:

CH₄+H₂O→CO+3H₂

The yield of hydrogen can be further increased by the water-gas conversion reaction (“shift reaction”) at lower temperatures:

CO+H₂O→CO₂+H₂

It is further possible to utilise crude oil for hydrogen production in a similar process.

Hydrogen produced in this way is referred to as “grey” because it comes from fossil fuels. If the carbon dioxide (CO₂) produced is subsequently captured from process exhaust gases and stored underground (CCS-carbon capture and storage), it is referred to as “blue” hydrogen. This was also obtained from fossil fuels, but the CO₂ emissions are prevented or at least drastically reduced. However, the CCS process is controversial worldwide and categorised as risky.

The pyrolysis of methane can also be used to produce CO₂-neutral hydrogen, as the product is solid carbon:

CH₄→C+2H₂

Hydrogen obtained in this way is referred to as “turquoise”. The disadvantage is that the yield is significantly lower than with steam reforming, but a major advantage is that no gaseous CO₂ is produced. Solid carbon is much easier to store or landfill and there are also possibilities for further material utilisation. This method is still not utilised on an industrial scale.

A further option is to utilise the methane from biogas plants. In this case, the hydrogen obtained is immediately “green”, even without CO₂ capture. As such biogas plants are relatively small, these methods are not very attractive economically.

The electrolysis of water is a further method for producing hydrogen. Today, around 4% of hydrogen produced worldwide is produced by electrolysis. However, such hydrogen is only “green” if the electricity used to produce it is also “green”. It is expected that electrolysis will be the main source of green hydrogen in the future. The problem is that the “green” electricity from solar and wind power plants is not always available. For this reason, the capacity utilisation of electrolysers is not high enough to enable economical operation. Once again, production in countries with significantly more hours of sunshine per year and corresponding exports to other countries will be necessary. However, transporting hydrogen is very expensive and has not yet been technically realised on a large scale.

The present invention is therefore based on the object of providing a method and an apparatus which enable hydrogen to be generated efficiently.

### SUMMARY OF THE INVENTION

Furthermore, the applicant has determined that the efficiency of such systems can be improved by controlling them accordingly. Furthermore, the operation of systems known from the state of the art has shown that their efficiency or performance decreases after a certain period of operation. Therefore, the invention is also based on the object of keeping the efficiency of such systems constant over longer periods of time.

These objects are also achieved by the subject matters of the following claims. It is further pointed out that the subject matters of the embodiments described as advantageous can be combined with one another in any desired manner.

In a method according to the invention for converting carbon-containing raw materials and in particular biomass into hydrogen, the carbon-containing raw material is first gasified in a gasifier or reactor, wherein heated water vapour is introduced into the gasifier or reactor and is used for gasification and/or steam reforming. Furthermore, the hydrogen-containing synthesis gas produced during gasification is then cleaned, wherein the gasification is an allothermal gasification and the heated water vapour is used both as a gasification agent and as a heat carrier for the gasification.

According to the invention, energy not used for hydrogen gasification is at least partially further used for the generation and/or overheating of water vapour. In addition or additionally, it is possible to use the synthesis gas at least partially for the generation and/or overheating of water vapour.

It is therefore proposed within the scope of the invention that energy which is lost during production is largely or at least partially used again for the production of water vapour. In this way, a particularly efficient production of hydrogen is possible.

In a further method according to the invention for converting carbon-containing raw materials and in particular biomass into hydrogen, the carbon-containing raw materials are gasified in a gasifier, wherein heated water vapour is introduced into the gasifier and used for gasification. In a further method step, the hydrogen-containing synthesis gas produced during gasification is cleaned, wherein the gasification is preferably an allothermal gasification and the heated water vapour is used both as a gasification agent and as a heat carrier for the gasification.

According to the invention, a variable characteristic of the conversion process is measured by means of two different measuring devices and the method and/or the apparatus carrying out the method is controlled by means of a control device taking this characteristic variable into account.

A-preferably continuous-measurement of a specific characteristic variable and control of the gasification process is therefore proposed.

The present invention is further directed to a method of operating an apparatus for converting carbonaceous raw materials, and in particular biomass, into hydrogen, wherein the following steps are carried out in a working operation of the apparatus. In a first method step, the carbon-containing raw materials are gasified in a gasifier device, wherein heated water vapour is introduced into the gasifier and used for gasification. Furthermore, the hydrogen-containing synthesis gas produced during the gasification is cleaned, wherein the gasification is preferably an allothermal gasification and the heated water vapour is used both as a gasification agent and as a heat carrier for the gasification.

Preferably, the chemical energy of the synthesis gas at the gasifier outlet is higher than the chemical energy of the fuel at the inlet. This increase in energy can be up to 130% or more. This can be achieved by converting the sensible heat of the water vapour into chemical energy.

According to the invention, in a cleaning mode of the apparatus, which differs in particular from the working mode, components of the apparatus and in particular of the gasifier device are cleaned, wherein in the course of this cleaning these components are cleaned with a flowable cleaning medium and in particular with heated water vapour.

In a preferred method, this above-mentioned characteristic quantity (which is measured) is a temperature, for example a temperature of the synthesis gas or of the water vapour.

In addition or alternatively, different measured values and/or process parameters are recorded using a plurality of measuring devices and/or sensor devices. In an advantageous method, measured values are preferably recorded and preferably also stored over a longer period of time. Particularly preferably, these measured values are stored with a time allocation. Thus, the measured values and/or process parameters are recorded over a period of time that is greater than 5 minutes, preferably greater than 30 minutes, preferably greater than one hour, preferably greater than 2 hours and particularly preferably greater than 5 hours.

Preferably, the measured values and/or process parameters are recorded continuously and/or clocked. In this way, a course of the measured values can also be determined.

For example, an n-tuple of measured values can be recorded at a certain point in time, such as two or several temperatures within the gasifier device, a temperature of the synthesis gas. During operation of the apparatus, such n-tuples of measured values can be repeatedly recorded and preferably also stored, particularly preferably with a time assignment. Furthermore, it is possible for correspondingly recorded measured values to be transmitted to a higher-level storage device at regular intervals.

It is possible for the recorded data to be transmitted to a central storage device, which can store and/or log the recording of the measured values, preferably over longer periods of time.

In a further preferred method, an evaluation device and/or processor device derives information from the data which are characteristic of the operation of the apparatus or the method. In a preferred method, artificial intelligence is used to evaluate this data, in particular in order to be able to make statements about future behaviour during the method or about the behaviour of the apparatus.

In a further preferred method, the characteristic variable is selected from a group of variables comprising a temperature of the water vapour occurring during gasification, a temperature of the synthesis gas, a pressure of the synthesis gas, a torque of a drive device which conveys the biomass to the gasifier, a flow rate and the like.

In a preferred method, the carbonaceous raw materials are fed to the gasification process by means of a conveying device and preferably this conveying device is controlled and in particular regulated on the basis of at least one characteristic variable.

It is conceivable and preferable that the characteristic variable is a drive torque of a drive unit of the conveying device. However, it would also be possible for control and/or regulation to take place on the basis of a temperature of the water vapour or the synthesis gas.

In a further preferred method, at least one parameter characteristic of a conveyor device is measured. Preferably, this can be, for example, a rotational speed of a conveying rake or a conveying screw or also a torque of a drive device of this conveying device.

Preferably, the conveyor device has an electrically operated drive unit and, in particular, an electric motor.

In a further preferred embodiment, the apparatus comprises a turbine and in particular a gas turbine. Preferably, the apparatus has a generator. In this way, the system can be operated autonomously.

In a further preferred method, a temperature characteristic of the gasification process is measured and, in particular, this temperature is measured at at least two different positions of a gasification device.

Particularly preferably, a conveying device is controlled and/or regulated as a function of this temperature. In a further preferred embodiment, the temperature is measured at at least three, preferably at least four, preferably at least five different positions and/or locations of the gasifier or the gasifier device. In a preferred embodiment, at least three, preferably at least four and preferably at least five temperature measuring devices are arranged on or in the gasifier device, which determine a corresponding temperature in different height zones. These temperatures are also used to control and/or regulate the feeding of the biomass or the material to be gasified.

Furthermore, a comparison device is preferably provided which compares the measured actual values of the temperatures with target values. Preferably, the conveying device is controlled on the basis of this comparison. This makes it possible to measure the actual temperatures occurring at the different positions of the gasifier device and compare them with the target temperatures to be expected there. If a deviation between the actual values and the target values is detected which is outside a predetermined tolerance range, the conveying device can be controlled accordingly.

In this case, a warning can also be issued to the user. The supply or temperature of the water vapour in the gasifier device can also be changed in response to these values.

In a further preferred method, a temperature and/or a pressure of the synthesis gas produced during gasification is measured. This pressure or temperature can also be characteristic of the gasification process or of downstream processes, for example. This is explained in more detail below. Preferably, this temperature is measured directly at an outlet point of the synthesis gas.

In a preferred method, the fuel is monitored by at least one sensor device. It is possible to determine the temperature of the synthesis gas in order to be able to draw conclusions about the fuel used or the material used for gasification.

It is also possible to determine an electrical or mechanical parameter of the above-mentioned conveying device for the material to be gasified, such as an electric current or a torque of a rake used for conveying. In this way, conclusions can be drawn about the material to be gasified.

It is also possible to determine the pH value of the biomass or the synthesis gas. This also allows conclusions to be drawn about the biomass used for gasification.

In a further preferred method, it would also be possible to monitor the conveying of the material to be gasified by an inspection device such as a video camera.

Preferably, the cleaning of the apparatus described above is carried out using a heated flowable cleaning medium. In a particularly preferred method, it is proposed that the same medium that is used for gasification is also used to clean the apparatus. In this way, the apparatus can be freed in particular from deposits such as in particular but not exclusively from tars.

In a preferred method, data of the cleaning process are monitored, such as in particular but not exclusively a duration of the cleaning, a temperature of the cleaning media used, pressures, flow rates and possibly also pressure curves. A cleaning mode and a working mode are particularly preferably different. It is therefore preferably not possible to carry out a cleaning operation during the working operation and, conversely, the working operation can preferably not take place during the cleaning operation.

In a preferred method, water vapour is heated to a predetermined temperature for cleaning purposes and the gasifier and/or connecting lines that carry the synthesis gas away from the gasifier are cleaned in this way. Particularly preferably, the water vapour is heated to a higher temperature for cleaning purposes than in an operating state or in working mode. Preferably, the temperature of the water vapour used for cleaning is between 150° C. and 800° C., preferably between 150° C. and 600° C. and particularly preferably between 200° C. and 500° C.

In a further preferred embodiment, the line pipes for the synthesis gas and/or the line pipes for supplying the water vapour are made of stainless steel.

In a preferred method, a process variable characteristic of the working operation is measured at least at times and preferably during the working operation and a cleaning operation is initiated on the basis of this process variable. This means that a certain process variable is measured and if this preferably exceeds or falls below a certain threshold value, cleaning of the gasifier device is triggered.

Preferably, the process variable is a pressure and, in particular, a pressure of the synthesis gas. Preferably, this pressure is measured continuously and particularly preferably over a longer period of time. In a preferred method, the pressure of the synthesis gas is measured at several positions of the apparatus. In a further preferred method, the pressure of the synthesis gas is measured by redundant measuring devices.

In a further preferred method, further components of the apparatus are cleaned, wherein preferably these components are selected from a group of components comprising valves, tubular devices, heat exchangers, coolers, filter devices and the like.

In a further preferred method, components of the apparatus are removed from the apparatus before or during the cleaning process.

In a further preferred method, the apparatus is at least temporarily cleaned and/or rinsed with a further cleaning medium which is different from the first cleaning medium mentioned above.

In a further preferred method, valves of the apparatus are switched at least temporarily during cleaning operation in order to clean different components of the apparatus. For example, it is possible for different heat exchangers or different cooling units to be cleaned using a corresponding circuit.

In a further preferred method, components of the apparatus are cleaned manually. For example, it is possible for certain components of the apparatus to be removed from it and cleaned manually. It is also possible, for example, for covers to be removed and then an in particular manual cleaning is carried out. In addition, it would also be possible for these components to be cleaned using a second cleaning medium.

In a further preferred method, components of the apparatus are bypassed or bypassed while cleaning is carried out. It is therefore possible that some units, for example the cooling units, are not cleaned using water vapour.

In a further preferred method, a consumption of cleaning agents, for example a consumption of water vapour, is determined. Particularly preferably, such a consumption is determined for each cleaning process. In this way, the efficiency of the cleaning process can be determined.

In a further preferred method, components of the apparatus, for example the gasifier, are inspected during or after a cleaning process. It is possible that the apparatus has an inspection device, such as a camera, which carries out this inspection.

In a further preferred method, components of the apparatus are freed from ice and or defrosted. It is conceivable that these components are exposed to a defrosting agent or are heated electrically or in some other way. Ice can also be removed mechanically. In a further preferred embodiment, the apparatus has electrically operated heating devices, which are used in particular for defrosting (in particular during a cleaning process).

In a further preferred method, a resumption operation is carried out after a cleaning operation in order to transfer the apparatus to the working operation and, preferably, the apparatus is operated with different process parameters during this resumption operation than during working operation.

It is therefore possible that water vapour is first generated and fed to the gasifier device during this start-up operation and then the carbon-containing products are fed to the gasifier.

Before commissioning the system, the pipes and components mentioned are preferably preheated to a temperature between 50° C. and 80° C. During commissioning, the synthesis gas temperature increases and therefore the power of the trace heating must also increase so that the wall temperature always follows the synthesis gas temperature.

Preferably, the lower part of the reactor 1 is filled with lime, dolomite, old ash (if available) or similar material. In this case, regenerators 20 and 21 supply only slightly overheated water vapour, approx. 200° C. to 300° C., to preheat the empty (without biomass!) reactor 1, cyclone 2, particle filter 5 and cracker 6.

The steam supply is then preferably stopped and the filling of reactor 1 is started. When reactor 1 is sufficiently filled with fuel, the steam supply is preferably started again so that the first quantities of synthesis gas are produced.

In a preferred method, the water vapour used for gasification has a temperature above 1000° C. in order to achieve allothermal gasification or steam reforming. Preferably, the temperature is above 1200° C. and particularly preferably above 1400° C. Allothermal gasification means in particular that the heat input comes from outside.

In this way, it is possible for the chemical energy of the synthesis gas at the gasifier outlet to be higher than the chemical energy of the fuel at the inlet. This increase in energy can be up to 130% and more.

Preferably, the method described here is divided into at least two process steps, wherein an allothermal gasification of the raw material (such as biomass and, for example, wood or straw) with water vapour, which serves as gasification agent and energy carrier, is carried out first. In the subsequent cleaning process, the gas is cleaned, in particular from dust and tar, and preferably a subsequent fed back into the gasification process is carried out.

By using the highly overheated steam as a gasification agent and energy source, a high water vapour surplus is achieved in the gasifier. This surplus is preferably always above two, particularly preferably above three.

Water vapour surplus can be defined as the amount of vapour by biomass input. In this case, the water vapour surplus is preferably >1, particularly preferably >2 (e.g. mass of water vapour by mass of biomass). This vapour surplus ensures that, on the one hand, the formation of tar is reduced and, on the other hand, the tars produced are significantly shorter-chain and therefore thinner than in the case of gasification without vapour surplus.

Preferably, the chemical energy of the synthesis gas at the gasifier outlet is higher than the chemical energy of the fuel at the inlet. This increase in energy can be up to 130% and more.

In a further preferred method, a further gaseous medium is fed to the gasifier together with the water vapour. Preferably, this is oxygen or air, which is heated together with the water vapour to the temperature of the water vapour and fed to the gasifier. In a further preferred method, the highest temperature within the gasifier is always above the ash melting point. In this way, it can be achieved that ash is discharged in the liquid state. Preferably, however, ash is discharged in solid form.

The gasifier is preferably a fixed-bed counterflow gasifier. In principle, various types of gasifier can be used according to the state of the art. However, the particular advantage of a fixed-bed counterflow gasifier is that individual zones are formed within this reactor in which different temperatures and therefore different processes occur. The different temperatures are based on the fact that the respective processes are highly endothermic and the heat only comes from below.

This is a particularly advantageous way of utilising the very high vapour temperatures. As the highest vapour temperatures prevail in the inlet zone of the gasification medium, it is always possible to create the conditions for liquid ash discharge. This is particularly advantageous in biomass gasification, where the ash melting points vary greatly depending on the type of fuel and the properties of the soil.

It is preferable to control the vapour temperature. In this way, sintering of the ash can be prevented. In a preferred method, lime is added or admixed. This is particularly possible with other fuels.

In an advantageous method, tar is separated from the synthesis gas and preferably at least a portion of this tar is fed back into the gasification process. Particularly preferably, the tar is injected into a high-temperature zone of a regenerator. Preferably, this regenerator is used to generate water vapour. Preferably, the tar is therefore fed to the water vapour generation process.

In a further advantageous method, the synthesis gas is cooled in a first cooling step and the thermal energy generated during this cooling is preferably used to overheat or generate water vapour. Preferably, this cooling is carried out by means of a heat exchanger and the correspondingly dissipated thermal energy is particularly preferably fed to the vaporisation process.

In a further preferred method, drying and/or separation of volatile hydrocarbons takes place. This can be carried out in conjunction with a cooling process, for example.

In a further preferred method step, the synthesis gas is cooled in a further cooling step, in particular a cooling step following the first cooling step, wherein a cooling device is preferably used for this further cooling step in which temperatures prevail which are below 50°, preferably below 40°, preferably below 30° and particularly preferably below 20°.

A so-called cryocooler is particularly preferably used in the second cooling step. This preferably allows complete drying of the synthesis gas. Particularly preferably, the synthesis gas is cooled to a temperature which is below 50°, preferably below 40°, preferably below 30°, preferably below 20°, preferably below 10° and preferably below 5° and particularly preferably below 0°.

For the cryocooler, it is advantageous to use the apparatus and methods described in part in DE 10 2014 112 401 A1. The disclosure content of DE 10 2014 112 401 A1 is hereby fully incorporated by reference into the present disclosure. The use of such apparatus and methods results in a more efficient solution compared to the state of the art.

In a particularly preferred embodiment, a cryocooler is used for cooling and this cryocooler particularly preferably has at least two interacting regeneration devices. These regeneration devices are particularly preferably designed in such a way that the synthesis gas passes through them one after the other.

Particularly preferably, at least temporarily, a first regeneration device is first run through and then a second regeneration device (by the synthesis gas), and at least temporarily the second regeneration device is first run through and then the first regeneration device (by the synthesis gas).

A refrigeration system is particularly preferably connected upstream of this second cooling device and/or the second cooling process. In this way, the low temperatures of the synthesis gas, which are advantageous here, can be achieved.

In a preferred method, the cooled synthesis gas is filtered, wherein a filter device is preferably used for this purpose, and in particular a carbon filter device and/or a zinc oxide filter device and/or a doped carbon filter. Preferably, several of these filter devices are used. Particularly preferably, this filtering takes place after cooling of the synthesis gas and in particular after the two-stage cooling process described above.

In a further preferred method, the cleaned and cooled hydrogen is compressed and, in particular, compressed at a pressure of at least 100 bar, preferably at least 200 bar and preferably at least 300 bar and preferably at least 350 bar. Preferably, the hydrogen is discharged in this compressed state. A compressor is particularly preferred for this purpose. The hydrogen gas compressed in this way can then be used.

In a further preferred method, the synthesis gas is compressed upstream of the PSA system. In a further preferred method, the separated hydrogen is then compressed further.

In a further preferred method, hydrogen and other gases are separated, in particular by a separation device, wherein a PSA system is preferably used for this purpose.

A waste gas from the separation device is particularly preferably used to generate and/or heat water vapour. This gas used can in turn be hydrogen. However, it would also be conceivable to use other gases such as methane.

It is therefore possible that the waste gas (tail gas or off-gas) from the PSA system is used, which contains gases such as CO, CO₂, CH₄ and a small amount of unused hydrogen. These gases still have a sufficient chemical content (or heating value) or a sufficient content of chemical energy. This energy is preferably used to generate water vapour.

In a preferred method, the carbonaceous raw materials are dried before gasification. Preferably, a combustion gas or the combustion gases from at least one regenerator are used for this drying. Preferably, this combustion gas has a temperature which is above the saturated vapour temperature and preferably between 20 K and 50 K above this saturated vapour temperature. In a preferred method, this combustion gas has a temperature which is greater than 120° C., preferably greater than 150° C. and particularly preferably greater than 170° C. Preferably, this combustion gas has a temperature which is less than 400° C., preferably less than 350° C. and more preferably less than 300° C.

Preferably, the raw materials are conveyed to the gasifier by means of a conveying device. This conveying device is particularly preferably selected from a group of conveying devices that includes screw conveyors, vibrating feeders, biomass sluices and the like

In a further preferred method, the synthesis gas is cleaned by a thermal cracker. Preferably, at least two interacting regeneration devices are used for this purpose. In this method, oxygen is particularly preferably supplied to the cracker for additional combustion. In particular, hydrogen is oxidised here, but other components of the synthesis gas can also be oxidised, such as CH₄ or CO, which also depends in particular on the temperature, the residence time and the chemical equilibrium.

Preferably, a corresponding apparatus for cracking gases has a feed line for a carbon-containing gas, by means of which the gas can be fed to a first heat exchanger with a bulk material of a thermal storage mass.

Preferably, the storage mass is alumina or aluminum oxide (Al₂O₃). Spheres of aluminum oxide are preferably used, which preferably have a diameter of between 2 mm and 20 mm.

In addition, fills made of natural materials such as lime, dolomite or olivine can also be used (in particular at lower temperatures).

A thermal cracker is particularly preferably used here, which breaks up the residual tars into short-chain molecular structures by means of very high temperatures, particularly advantageously between 800° C. and 1400° C. and preferably also by supplying a small amount of oxygen or air. In this so-called thermal cracking, the synthesis gas is thus brought to a very high temperature, whereby the long-chain molecular structures are broken down into short chains. At the same time, this process removes the remaining amount of dust. (Additional energy is preferably provided to cover reaction heat during the cracking process)

Preferably, the synthesis gas in the cracker is first heated and then cooled again. Preferably, the temperature differences during heating and subsequent cooling differ by no more than 40°, preferably by no more than 30°, preferably by no more than 20° and particularly preferably by no more than 10°.

In a further method, only dust is removed from the synthesis gas by means of a cyclone (centrifugal separator), so that the tars remain in the synthesis gas. (Dust and tars are preferably partially separated in the cyclone) This is preferably ensured by electrical trace heating, with which the pipelines and the cyclone are kept at temperatures above the condensation temperature of the tars. The remaining tars are removed from the synthesis gas in a condenser together with the water. This “tar water” forms a pumpable suspension, which is vaporised, overheated and fed back into the gasification process.

The processing of the synthesis gas is described in more detail below.

Preferably, a first combustion chamber arranged downstream in the direction of flow of the gas is provided, which in particular has a controllable supply device for another oxygen-containing gas, by which partial oxidation of the carbon-containing gas takes place (in particular by sub-stoichiometric oxygen supply).

Furthermore, a reactor arranged downstream in the direction of flow of the gas of the first combustion chamber is preferably provided, which has a bulk material of a possibly catalytically active material for the catalytic decomposition of impurities in the carbon-containing gas.

A second combustion chamber is particularly preferably provided downstream of this reactor in the direction of flow of the carbon-containing gas, with a particularly controllable supply device for an oxygen-containing gas, by which a partial oxidation of the catalytically prepared carbon-containing gas is achieved by (in particular sub-stoichiometric) oxygen supply, and a second heat exchanger with a fill of a thermal storage mass is preferably arranged downstream of this combustion chamber in the direction of flow of the gas, wherein the direction of flow of the carbon-containing gas is particularly preferably reversible at least in a region which includes the first and second heat exchangers, the first and second combustion chambers and the reactor.

For the thermal cracker, it is advantageous to use the apparatus and methods described in part in DE 10 2012 111 900 A1, DE 10 2012 111 894 A1, or EP 2 928 991 A1. The disclosure content of the aforementioned publications is hereby fully incorporated by reference into the present disclosure. The use of such apparatus and methods leads to a more efficient solution compared to the state of the art.

The present invention is further directed to an apparatus for the conversion or steam reforming of carbonaceous raw materials and in particular of biomass into hydrogen. This has a gasification device for gasifying the carbonaceous products. In addition, the apparatus has a supply device which introduces heated water vapour into the gasification device in order to use it for gasification. Furthermore, the apparatus has a cleaning device for cleaning the hydrogen-containing synthesis gas produced during gasification, wherein the gasification is an allothermal gasification and the heated water vapour is used both as a gasification agent and as a heat carrier for the gasification. According to the invention, the apparatus comprises a recovery device for reusing energy no longer useful for hydrogen production for the production and overheating of water vapour. Preferably, the chemical energy of the synthesis gas at the gasifier outlet is higher than the chemical energy of the fuel at the inlet. This increase in energy can be up to 130% or more. Preferably, this energy increase is at least 10%, preferably at least 20% and preferably at least 40% and particularly preferably at least 50% and particularly preferably at least 60%.

Particularly preferably, the apparatus has a heating device for heating water vapour. In particular, the apparatus has at least two and particularly preferably at least three interacting regenerators.

The present invention is further directed to an apparatus for converting carbonaceous raw materials, and in particular biomass, into hydrogen. This apparatus has a gasification device for gasifying the carbon-containing raw materials, as well as a supply device which introduces heated water vapour into the gasifier in order to use it for gasification. Furthermore, a cleaning device is provided for cleaning the hydrogen-containing synthesis gas produced during gasification, wherein the gasification is preferably an allothermal gasification and preferably the heated water vapour is used both as a gasification agent and as a heat carrier for the gasification.

According to the invention, the apparatus has a control device for controlling the conversion process and furthermore the apparatus has at least one first sensor device for detecting a first measured value characteristic of the conversion process and at least one second sensor device for detecting a second measured value characteristic of the conversion process, and the control device controls the conversion process both on the basis of the first and on the basis of the second measured value.

The present invention is further directed to an apparatus for converting carbonaceous raw materials, and in particular biomass, into hydrogen. This has a gasification device for gasifying the carbon-containing raw materials, as well as a supply device which introduces heated water vapour into the gasification device in order to use this for gasification. Furthermore, the apparatus has a cleaning device for cleaning the synthesis gas produced during the gasification, wherein the gasification is preferably an allothermal gasification and preferably the heated water vapour is used both as a gasification agent and as a heat carrier for the gasification.

According to the invention, the apparatus has or enables a cleaning mode for cleaning components of the apparatus and in particular of the gasifier, wherein these components can be cleaned with a flowable cleaning medium and in particular with water vapour as part of this cleaning mode.

In a further (alternative or additional) embodiment according to the invention, the apparatus has at least two different measuring devices which measure a variable characteristic of the conversion process, and a control device is provided which controls the apparatus taking this characteristic variable into account.

It is therefore also proposed in the context of the apparatus according to the invention that at least two measuring devices record measured values characteristic of the conversion process and that the apparatus is controlled taking these measured values into account. Preferably, the measuring devices are suitable and intended to record the measured values continuously over a certain period of time.

Preferably, the apparatus has at least four temperature measuring devices for determining temperatures of the gasifier device and at least one temperature measuring device for determining a temperature of the synthesis gas.

In a further preferred embodiment, the apparatus has an analysing device for analysing the synthesis gas with regard to its components.

In a further preferred embodiment, the apparatus has a detection device for detecting an oxygen content of the synthesis gas.

Preferably, the apparatus has a conveying device for conveying the carbon-containing products and preferably the control device controls this conveying device taking into account the aforementioned measured values.

Preferably, the apparatus has a heating device for overheating water vapour and preferably this heating device is also controlled and regulated as a function of measured values

In a further advantageous embodiment, the apparatus has at least one and preferably at least two cooling devices for cooling hydrogen-containing synthesis gases. Particularly preferably, at least two cooling devices are provided for cooling the hydrogen-containing synthesis gas, which are preferably arranged one behind the other in the direction of flow of the synthesis gas. These may be cryocoolers, for example.

Preferably, the apparatus has at least one generating device and preferably at least two generating devices for generating water vapour. Preferably, the generating device for generating and in particular for overheating water vapour is a recuperator and particularly preferably a bulk material regenerator.

Particularly preferably, this bulk material regenerator has a heat storage mass of bulk material, which is arranged within a container and which is particularly preferably arranged within two cylindrical grids that are coaxial with each other.

Preferably, the inner of these two grates surrounds a hot collecting chamber for the hot gases. A circumferential wall is preferably arranged around the outer cylindrical grate and a collecting chamber for cold gases is particularly preferably provided between the outer cylindrical grate and this wall.

Preferably, an increase in pressure loss during a heating phase of the bulk material regenerator is at least times as large as the value of rho·g·H, wherein rho or delta rho: is the gas density at a temperature of 20° C., g is the acceleration due to gravity and H is the height of the regenerator, and wherein preferably the throughput rate for the gas is at least 300 Nm3/h·m2 area of the hot grate at normal pressure. 2

In a further preferred method, the grain size of the bulk material is smaller than 15 mm. Preferably, the grain size of the bulk material is greater than 2 mm.

Preferably, the outer diameter of the annular heat storage mass is at most twice as large as the inner diameter. In a further preferred embodiment, the bulk material regenerator is heated with a premix burner.

A regenerator of the type described here is particularly suitable for the generation of hydrogen described here.

In a preferred embodiment, at least one bulk material regenerator has a circulating device and/or a recirculating conveyor device for circulating and/or recirculating bulk material. Preferably, circulation of the bulk material can also be enabled during operation. It would therefore be possible for bulk material to be removed from a first area of the bulk material regenerator and fed to another area of the bulk material regenerator.

Preferably, the bulk material is circulated and/or conveyed in this way at predetermined intervals, for example 1-2 times a day.

Preferably, the apparatus has a measuring device which is suitable and intended to determine a discharge quantity of bulk material from the bulk material regenerator. This may, for example, be a weight measuring device. Preferably, during the circulation and/or recirculation of the bulk material, a predetermined proportion of the bulk material is located outside an active zone, i.e. outside a zone in which the bulk material is used for heating. This proportion is preferably between 1% and 2% of the total quantity of bulk material.

In a further preferred embodiment, the sensor device described above is selected from a group of sensor devices comprising temperature measuring devices, pressure measuring devices, humidity measuring devices, torque measuring devices, flow measuring devices and the like. Preferably, the sensor device is suitable and intended for detecting a temperature of the water vapour. Particularly preferably, the measuring devices are at least partially designed as measuring probes.

In a further preferred embodiment, the apparatus has a sensor device which determines the components of the synthesis gas, in particular the proportions of different gases. In addition, a measuring device is preferably also provided which determines an oxygen content of the synthesis gas.

In a preferred embodiment, measuring devices are arranged at least partially redundantly. For example, a temperature measuring device for measuring a temperature of the water vapour or a temperature of the synthesis gas can be arranged redundantly so that operation can be continued if a measuring device fails.

In a preferred embodiment, the apparatus has a timer which is suitable and intended for controlling individual parts of the system. In a further preferred embodiment, the apparatus has a display device which shows the measured values displayed. It is also possible for this display device to communicate wirelessly with the individual measuring devices.

In a preferred embodiment, the display device is suitable and intended for displaying values indicated by the measuring devices. Preferably, a measured value is also assigned to a specific measuring device. It is thus possible for the display device to show a representation of the complete display and to show at which point which measured values were recorded. In a preferred embodiment, the display device is portable, for example in the form of a portable touchscreen. In this way, the operator can monitor and/or control the apparatus from different locations.

In a further preferred embodiment, at least one measuring device has a transmitting device which is suitable and intended to output a measured signal wirelessly. Preferably, this measuring device and/or the transmitting device is suitable and intended to output an identification in addition to the measured value, which in particular uniquely identifies the measuring device.

Preferably, at least one of these sensor devices is interchangeable. In a further preferred embodiment, the apparatus has an operating device by which a user can control or regulate certain parts of the system or can influence their control or regulation. It is thus possible for a user to adjust valves automatically or to regulate the supply of biomass to the vaporiser device. In a further preferred embodiment, a sensor device is provided which measures the degree of moisture of the biomass to be fed. In addition, sensor devices can also be provided which determine a temperature of the above-mentioned pebble heater. In addition, a sensor device can also be provided which enables the temperature measurement of the already cooled medium, for example the cooled hydrogen, to be measured.

In a further preferred embodiment, the apparatus has at least one sensor device that determines at least one environmental parameter. For example, a temperature measuring device can be provided which measures an ambient temperature or a measuring device for determining an air humidity or an air pressure.

In a preferred embodiment, the apparatus has a conveying device driven by a drive device, which conveys the carbonaceous products to the gasifier device, and this conveying device and/or the drive device is preferably controlled as a function of at least one measured value.

In a preferred embodiment, the gasifier device has at least two, preferably at least three and preferably at least four temperature measuring devices, which measure temperatures in different areas and/or zones of the gasifier device. Preferably, the apparatus has at least five, preferably at least six, such temperature measuring devices. Particularly preferably, the conveying device and/or the conveying drive is controlled taking these temperature values into account.

In a preferred embodiment, the apparatus has at least one and preferably at least two pressure measuring devices, which are preferably arranged at different positions on the apparatus. The pressure measuring devices are particularly preferably suitable and intended for determining a pressure drop or a pressure difference. It is therefore possible for one of the pressure measuring devices to be arranged downstream of the second pressure measuring device. In this way, for example, it is possible to determine whether a cleaning process should be carried out on the apparatus.

Preferably, at least one temperature measuring device is also assigned to the generation and/or overheating device for heating water vapour and preferably at least two temperature measuring devices. These can, for example, be located on the input side and output side of the overheating device. The temperature values measured by these temperature measuring devices can be used to control the apparatus and, in particular, to control the overheating of the water vapour.

In a further advantageous embodiment, the apparatus has a (in particular electronic) storage device for storing a plurality of the measured values measured by different measuring devices. It is possible for the storage device to record such measured values over a longer period of time. Particularly preferably, the storage device is suitable and intended for recording and/or determining the measured values with a time assignment. Particularly preferably, these measured values are recorded with a time value characteristic of a point in time. In a particularly preferred embodiment, the apparatus has a timer device.

In a preferred embodiment, the apparatus has a warning device which indicates a cleaning process to be carried out and/or faults during operation of the apparatus. In addition, the apparatus preferably has a storage device which records characteristic cleaning data.

This can be, for example, a consumption of a cleaning medium, a temperature at which the cleaning was carried out, a duration of the cleaning and the like. In a further preferred embodiment, the apparatus has a processor device, and in particular a remotely arranged processor device, by means of which remote maintenance and/or remote cleaning is made possible.

In a further advantageous embodiment, the apparatus has a supply device for supplying a second cleaning agent, such as an additive, to the first cleaning agent, for example water vapour. In this way, cleaning agents that improve the cleaning of tars, for example, can also be used in addition to the water vapour.

In a further preferred embodiment, the apparatus has at least one measuring device which detects a parameter characteristic of the working operation of the apparatus. As mentioned above, this may, for example, be a temperature measuring device, a pressure measuring device and the like.

In a further advantageous embodiment, the apparatus has a further combustion chamber, which is used in particular to carry out the cleaning process. Preferably, this is a post-combustion chamber, which is used in particular to further overheat water vapour.

In a further preferred embodiment, the apparatus has a supply device for supplying (additional) oxygen. In particular, an additional amount of oxygen can be supplied for cleaning purposes and/or to carry out the cleaning process in order to further overheat the water vapour for cleaning purposes.

In a preferred embodiment, the supply of (additional) oxygen takes place in reaction and/or in consideration of at least one measured value, for example in reaction and/or in consideration of a measured temperature, for example a measured temperature of the water vapour.

For further details regarding the bulk material regenerators, reference is made to EP 0 620 909 B1 or DE 42 36 619 C2. The disclosure content of EP 0 620 909 B1 and DE 42 36 619 C2 is hereby fully incorporated by reference into the present disclosure. The use of such bulk material regenerators leads to a more efficient apparatus compared to the state of the art. With regard to DE 42 36 619 C2, reference is made in particular to column 2, line 55 to column 4, line 37.

The invention proposed here relates to a method and apparatus for converting chemical energy from carbonaceous raw materials that are CO₂ neutral in hydrogen. Raw materials can be various biomass (e.g. wood, wood residues, waste wood, agricultural waste, straw, fast-growing plants, waste from the food industry, fermentation residues, spent grains), organic waste (e.g. domestic waste, household waste, RDF-“refuse derived fuel”, industrial waste) and the like.

The method of allothermal steam reforming of carbonaceous raw materials according to the invention utilises the chemical energy of the raw material in order to use the carbon content as much as possible for hydrogen production. The method achieves an extremely high yield of hydrogen through the use of very highly overheated water vapour, which acts simultaneously as an energy source and as a reactant. The energy that can no longer be used to generate H₂ is used to generate and overheat water vapour, resulting in a very effective allothermal reaction. All this results in a very economical process for CO₂-neutral hydrogen production. Preferably, the chemical energy of the synthesis gas at the gasifier outlet is higher than the chemical energy of the fuel at the inlet. This increase in energy can be up to 130% and more. Preferably, this energy increase is at least 10%, preferably at least 20% and preferably at least 40% and particularly preferably at least 50% and particularly preferably at least 60%.

### BRIEF DESCRIPTION OF THE DRAWINGS

Further advantages and embodiments are shown in the attached drawings:

In the drawings:

FIG. 1 shows a schematic representation of an apparatus according to the invention;

FIG. 2 shows an illustration of an advantageous thermal cracker;

FIG. 3 shows an illustration of a cooling device for cooling the synthesis gas;

FIG. 4 shows an illustration of the use of tars;

FIG. 5 shows a further advantageous embodiment of the present invention;

FIG. 6 shows an illustration to visualise the control of the gasifier device; and

FIG. 7 shows an illustration to visualise the process sequence.

### DETAILED DESCRIPTION OF THE DRAWINGS

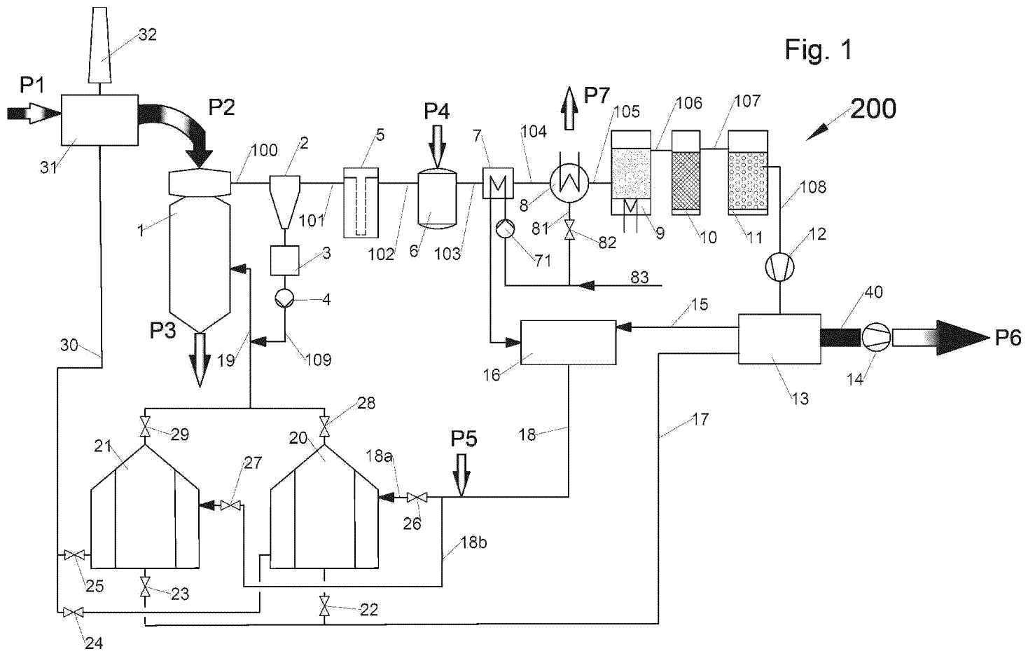

FIG. 1 shows a schematic representation of an apparatus 200 according to the invention for producing hydrogen from carbonaceous raw materials. The reference sign 1 refers to a high-temperature reactor or gasifier in which the raw material enters along the arrow P2. The reference sign 31 indicates an optional drying device for drying the raw material. A gas or a gas mixture comes out of the line 19, which serves as an energy source for the reaction and as a reactant.

Furthermore, the apparatus preferably has a transport device which conveys the raw material from the drying device to the high-temperature reactor. This transport device preferably has at least one and preferably several conveyor belts, at least one screw conveyor and/or at least one or several scraper chain conveyors. The raw material can be conveyed continuously or clocked.

This gas coming from the line 19 preferably consists of or has very highly overheated water vapour. This preferably enables allothermal production of synthesis gas. If the raw material used contains mineral components, these leave the reactor along arrow P3 as ash. Depending on the prevailing temperature in this area of the reactor and the ash composition, the ash can be discharged in a solid or liquid state.

Starting from the reactor 1, the synthesis gas produced, which contains a large amount of hydrogen, passes through a pipe 100 into a cyclone, or preferably into a multi-cyclone. In this cyclone 2, a large proportion of the tar and the dust produced is separated out and temporarily stored in a reservoir 3. This cyclone thus represents a cleaning device for cleaning the synthesis gas

Preferably, a pump 4 is used to transport the tar through a line 109, inject it into the line 19 and feed it back into the process. The injection point can be just before the reactor 1 or already in the reactor.

The thus pre-cleaned synthesis gas, in which residual tar is present together with residual amounts of dust, passes through a further line 101 into a particle filter 5, where the dust is almost completely removed so that only gaseous, highly volatile tars are still present in the synthesis gas. These are preferably destroyed in a thermal cracker 6, where the gases are channelled via line 102.

The apparatus therefore preferably has two successive cleaning devices for cleaning the synthesis gas. Preferably, the synthesis gas is conveyed through the system by the pressure originating from the water vapour.

The preferred temperatures in the cracker are well above 800° C., so that in addition to the tars, the methane contained in the synthesis gas is also cracked or pyrolysed. In this way, the H₂ content in the synthesis gas increases further. In order to maintain the high temperature or to achieve the reaction energy, a predetermined amount of oxygen or air is preferably fed to the cracker along arrow P4. This oxidises part of the synthesis gas (H₂, CO, or CH₄) and the necessary energy is released.

After the thermal cracker, the synthesis gas enters a gas cooler 7 via a line 103. In this gas cooler, the synthesis gas is cooled to such an extent that excess water vapour is condensed out in the condenser 8 downstream through a line 104. Preferably, the waste heat (P7) can be used to dry the biomass. Alternatively, the waste heat can also be fed into a local heating network.

Depending on the capacity of the system, the diameter of this pipeline is between at least 100 mm and normally 800 mm. In extremely large plants, the pipes can also have a diameter of over 1.000 mm. The pipes are particularly preferably made of stainless steel in order to withstand the high temperatures on the one hand and the aggressive components of the synthesis gas (such as formic acid or sulphuric acid) on the other.

The outgoing synthesis gas still contains a quantity of residual moisture, depending on the prevailing pressure and temperature. For this reason, the gas mixture is preferably fed through a line 105 into a cooling device, preferably cryo-cooler 9, in which temperatures below 20°, preferably below 10° and particularly preferably 0° C. and particularly preferably below −5° C., and particularly preferably below −10° C. prevail. This completely dries the synthesis gas and removes volatile gaseous hydrocarbons, such as benzene, toluene, naphthalene, etc., depending on the temperature.

In a preferred process, the synthesis gas is cooled in at least three stages.

In order to remove any further pollutants (furans, sulphur, etc.), a carbon filter 10 (alternatively: gas scrubbing) is connected downstream via a line 106, and preferably a zinc oxide filter (or a doped carbon filter for sulphur adsorption) 11 is connected further downstream via a line 107. The completely purified synthesis gas is compressed via a line 108 in the compressor 12 to a pressure suitable for hydrogen separation. Preferably, this pressure is in a range between 10 bar and 25 bar, preferably between 12 bar and 20 bar. Additionally or alternatively, it would also be possible to carry out gas scrubbing

To remove hydrogen from other gases from synthesis gas, a PSA (pressure swing adsorption) system 13 is preferably used. The separated hydrogen passes through a line 40 into an H₂ compressor 14, where it is compressed to 350 bar or even higher pressures. Compressed hydrogen is ready for further use and leaves the plant along arrow P6.

The tail gas (off-gas) from the PSA system 13 contains gases such as CO, CO₂, CH₄ and a small amount of unutilised H₂, with a sufficient content of chemical energy. This energy is used to generate water vapour (via a pipe 15) or to overheat the water vapour (via a pipe 17).

Line 15 feeds part of the tail gas into a steam generator 16, where saturated steam is produced. The feed water is preferably the condensed water from the condenser 8, to which fresh water from a line 83 is added via a line 81 and a metering valve 82. A quantity of fresh water (approximately ⅓ of the feed water) is necessary because it is consumed by the reaction with the carbon in the reactor 1 for hydrogen production.

A feed water pump 71 is used to generate the correct pressure for the steam boiler 16 and the saturated steam produced, or for the entire system 200. Before entering the boiler 16, the feed water is preheated in the heat exchanger 7 by utilising the heat from the synthesis gas. Both, fresh water from line 83 and condensed water from line 81, are treated to the required quality for the boiler 16 in corresponding systems, which are not shown here.

Preferably, the apparatus according to the invention has a water treatment device.

The saturated steam then passes via a connecting line 18, which is split into two partial lines 18a and 18b, into two heating devices, preferably two regenerators 20 and 21. The water vapour is overheated to the required temperature in these regenerators. In the apparatus shown in FIG. 1, two regenerators 20 and 21 are provided, which preferably enable continuous operation of the system.

While the water vapour is overheated in the regenerator 20, the regenerator 21 is in a heating phase, i.e. it is charged with thermal energy, in particular by the combustion of the second part of the tail gas 17 from the PSA system 13. A plurality of valves 22 to 29 are used to control the two regenerators.

Valves 22, 24, 26 and 28 are assigned to regenerator 20 and valves 23, 25, 27 and 29 are assigned to regenerator 21. The two regenerators 20 and 21 can be operated alternately by switching over, for example by periodically switching over the valves 22 to 29 shown. By utilising the energy of the tail gas 15 and 17, this energy is fed back into the process in the form of very highly overheated water vapour through line 19.

It is possible that the switchover is controlled by means of a timer, i.e. that a switchover preferably takes place during operation at predetermined times or in predetermined periods. Furthermore, it is also possible for a switchover to take place on the basis of other parameters, such as a temperature measurement. Combinations of both control systems are also possible.

For example, a time-dependent control system can be provided primarily, wherein an additional check is made to see whether a switchover is also indicated by corresponding temperatures. It is also possible for a machine operator to be prompted to perform a changeover.

The combustion gases produced in each case leave the regenerators through a line 30 and enter a drying unit 31, where their sensible heat is utilised to significantly reduce the water content of the moist raw material entering the plant 200 along arrow P1. In this way, the water content of the dried raw material entering the reactor 1 along the arrow P2 is reduced to well below 10%, which means an increase in the efficiency of the entire plant 200. (10% at 50% input)

The utilisation of the chemical energy of the tail gas 15 and 17 from the PSA system 13 and the utilisation of the waste heat from the gas cooler 7 for the feed water preheating, together with the drying system 31 described above, result in a high efficiency of the entire system 200 and economical hydrogen production. In a preferred method, synthesis gas is admixed, in particular if the tail gas quantity is insufficient)

Instead of the two regenerators 20 and 21 shown in FIG. 1, three or even several regenerators can also be used in order to achieve particularly uniform operation.

Along the arrow P5, another gas, or a gas mixture, can be fed into the line 18 to the water vapour. This can be a surplus tail gas from the system 13 or a quantity of exhaust gas which is branched off from the line 30 from the regenerators 20, 21. It can also be an external gas from outside the system 200. In this way, the water vapour surplus in the reactor 1 can be reduced and thus further improve the efficiency.

It is also possible to optimise the whole process to increase the yield of another by-product, such as benzene, to further increase the profitability. If the raw material is particularly dry, there is no need for the dryer 31. In this case, the waste heat from the exhaust gases in line 30 can be utilised for other purposes, e.g. for a local heating network.

The waste heat from the condenser 8, along arrow P7, can also be utilised, e.g. also for a local heating network, for additional drying of the raw material, or for preheating the fresh water from the line 83. In addition, an air cooler (not shown) can be provided.

If the raw material along arrow P1 is of very good and clean quality, it is possible to dispense with one or several downstream cleaning components, such as particle filter 5, cryo-cooler 9, carbon filter 10 and/or ZnO filter 11. Depending on the impurities in the synthesis gas, the order of components 9, 10, 11 can be changed in order to achieve an optimum result.

For this purpose, a bypass line can be provided that bypasses one or several parts of the system. The synthesis gas can be channelled via this bypass line by means of valves.

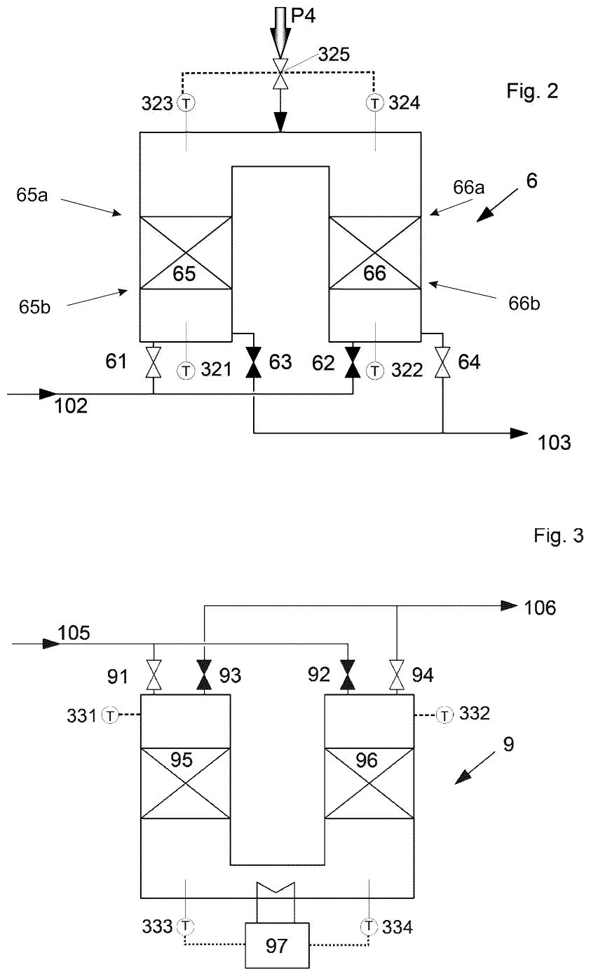

FIG. 2 shows a detailed illustration of a particularly advantageous embodiment of the thermal cracker 6 shown in FIG. 1. In order to achieve low energy consumption of the system, despite very high temperatures in the cracking zone, two interacting regenerator devices and in particular regenerator layers 65 and 66 are again preferably used. A plurality of valves 61 to 64 are used to control the two regenerators.

The reference signs 65a and 66a each indicate the upper or warmer areas/sides of these layers and the reference signs 65b and 66b each indicate the lower or cooler areas/sides of these layers. These layers can be arranged radially or axially next to each other.

The raw synthesis gas flows out of the line 102, through the valve 61 and the regenerator layer 65, where it is preheated to a very high temperature, preferably well above 800° C. This temperature causes spontaneous thermal cracking of the tars and methane. This temperature causes spontaneous thermal cracking of the tars and methane. Since the synthesis gas contains a high surplus of water vapour, additional quantities of hydrogen are produced. Preferably, the synthesis gas passes through the above-mentioned layers one after the other.

In order to cover the energy requirement for cracking and the energy losses of system 6, a small amount of the synthesis gas is preferably post-combusted, which is why oxygen is preferably supplied along arrow P4. Instead of oxygen, air can also be supplied and, in particular, injected: one advantage of this procedure is lower costs, but a major disadvantage is that the synthesis gas will also contain nitrogen.

Hot cracked synthesis gas preferably flows through the second regenerator layer 66 so that it is cooled down again and, in particular, brought to almost the inlet temperature. The outlet temperature is normally only 5K to 50K above the inlet temperature.

The gas leaves the system through the valve 64 and flows further through the line 103. After a certain time, the action of the two regenerators alternates due to the control of valves 61 to 64.

Instead of the two regenerators 65, 66 shown in FIG. 2, three or several regenerators, preferably always connected at the hot side, can also be used. This will make it possible to achieve particularly uniform operation, including a rinsing phase.

The control of the crackers 6, or the switchover between the regenerator layers 65 and 66 on FIG. 2, runs as a function of time and/or as a function of temperature. Each phase lasts a certain time, Δtc, usually between 2 and 5 minutes.

When this time has elapsed, the flow direction is preferably changed by actuating valves 61 to 64 and a new operating phase starts. During this time Δtc, the temperature at the outlet, measured at measuring points 321 or 322, rises. If this temperature exceeds a certain limit value TC1, valves 61 to 64 are switched over in order to protect the components from overheating. This means that the temperature is preferably the second switchover criterion there as well.

In the high temperature zone above the layers 65 and 66, there is a high reaction temperature TC2, which is preferably specified in order to achieve the desired cracking of higher hydrocarbon molecules. The measuring points or temperature measuring devices 323 and 324 measure the temperature in this zone. Since the cracking reactions are endothermic, the temperature drops in the direction of flow and a quantity of oxidising agent (oxygen, air, . . . ) must be added along arrow P4.

This oxidises a proportion of the synthesis gas and the necessary high-temperature heat is generated. Depending on the temperature measurements 323 and 324, the valve 325 regulates the amount of oxidising agent in order to keep the desired temperature TC2 as stable as possible.

If the system 6 is designed with layers 65 and 66 with radial flow, it is preferable to use the recirculation as in the regenerators 20 and 21 in order to control or reduce the thermal stresses in the radial direction. However, even with the axial design of layers 65 and 66, it is preferable to regularly remove a small amount of the bed material from below and reintroduce it at the top. In the centre layers of the bed deposits of soot particles arise, which can increase the pressure loss and prevent free flow. By recirculating the bed material, the soot particles reach the high temperature zone, where soot disappears again.

FIG. 3 shows a detailed illustration of a particularly advantageous embodiment of the cryocooler 9 shown in FIG. 1. In order to achieve low energy consumption of the system, despite very low temperatures in the cold zone, two interacting regenerator layers 95 and 96 are preferably used again. These layers can consist of gravel, for example.

A plurality of valves 91 to 94 are used to control the two regenerators. The large water vapour surplus in the synthesis gas is preferably removed beforehand in the condenser 8, but preferably depending on the temperature and pressure prevailing there. A small amount of residual moisture can still remain, which can cause problems for trouble-free operation in downstream components.

For this reason, the synthesis gas preferably flows out of the line 105, through the valve 91 and the regenerator layer 95, where it is cooled to a very low temperature, at least below 0° C. or well below 0° C. if required. This temperature causes the residual moisture to condense out and the synthesis gas becomes completely dry. The extremely volatile gaseous hydrocarbons, such as benzene, toluene, naphthalene, etc., will also condense. It is possible to extract some of these chemicals and utilise them further for other processes, which increases the economic efficiency of this plant 200.

In order to maintain the low temperatures and to cover the cooling losses of the system 9, a refrigeration system 97 is preferably installed downstream. Cold and/or dried synthesis gas flows through the second regenerator layer 96 so that it is cooled almost back to the inlet temperature. The gas leaves the system through the valve 94 and flows further through the line 106. Preferably, the synthesis gas is first cooled and then heated in this process

After a certain time, the effects of the two regenerators alternate by activating the valves 91 to 94. Instead of the two regenerators 95, 96 shown in FIG. 3, three or several regenerators, which are preferably always connected on the cold side, can also be used. This makes it possible to achieve particularly uniform operation, including a flushing phase.

The control of the cryo-cooler 9, or the switching between the regenerator layers 95 and 96 in FIG. 3, is preferably carried out according to time and/or temperature. Each phase lasts a certain time, Δtcc, usually between 2 and 5 minutes.

As soon as this time has elapsed, the flow direction is changed by actuating valves 91 to 94 and a new operating phase starts. During this time Δtcc, the temperature at the outlet, measured at the measuring devices or measuring points 331 or 332, decreases. If this temperature falls below a certain limit value TCC1, valves 91 to 94 are preferably switched over before the time has elapsed in order to keep the efficiency of the system high or to keep the energy consumption of the cooling unit 97 low. A time and temperature control is therefore preferably carried out here.

The low temperature zone below layers 95 and 96 has a very low temperature TCC2, which is specified to achieve the desired drying of the synthesis gas at the same time as the elimination of the very volatile, residual tar fractions (such as naphthalene). Measuring points 333 and 324 measure the temperature in this zone. In order to cover the condensation heat, the cooling unit 97 must remove the heat generated. Depending on the temperature measurements 333 and 334, the output of the unit 97 is preferably regulated in order to keep the desired temperature TCC2 as stable as possible.

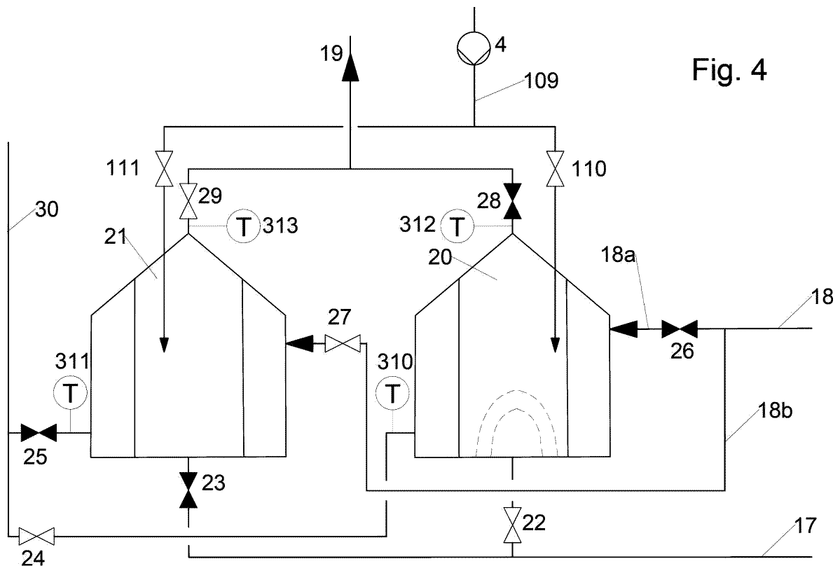

FIG. 4 shows a further preferred embodiment. The tars from the line 109 are injected directly into the high temperature zone of the regenerators 20, 21. During a combustion phase, the injected tars oxidise and contribute to preheating the regenerators 20 in FIG. 4. This is particularly advantageous if the amount of energy of the tail gas from line 17 is not sufficient.

If the tars are injected during a steam overheating phase, as in regenerator 21 in FIG. 4, the tars react with the steam. This steam reforming immediately produces additional quantities of H₂, together with some CO/CO₂, and so the temperature of this gas mixture is reduced. In this way, the thermal load on the hot blast gates 28, 29, line 19 and the high-temperature section of reactor 1 is significantly reduced with the same energy input.

By actuating the valves 110, 111, it is possible to select in which operating phase of the regenerators 20, 21 the tars are to be injected.

The control or switching of the regenerators 20 and 21 in FIG. 4 is preferably time-dependent and/or temperature-dependent. Each heating or steam phase takes a certain time, Δth or Δtd. If only two regenerators are provided, Δth<Δtd, as a short time is needed to bring all the valves into the correct position.

In this way, the supply of overheated steam is preferably (absolutely) continuous and the rest of the process in reactor 1 and in the entire plant 200 runs without interruption. If three or several regenerators are used, the heating phase is correspondingly longer, but with reduced flow. e.g., with three regenerators, a heating phase is slightly shorter than twice the steam phase: 4th<2Δtd. In this way, the pressure drop of a heating phase can be kept approximately the same as for the steam phase. Combustion normally takes place at ambient pressure and the steam phase at elevated pressure.

The second preferred switching criterion is the temperature. During each heating phase, the temperature of the exhaust gas, measured at measuring point 310 or 311, increases. If this temperature increases above a predetermined limit temperature TG1, the heating phase is terminated and returns to the steam phase. The reason for this is to protect the material from overheating, but also to keep the efficiency of the system high.

In the case shown in FIG. 4 (regenerator 20 is in the heating phase), the heating phase is ended before the time Δth has elapsed if the temperature at measuring point 310 has reached the value TG1.

The temperature as a switching criterion also applies preferably to a steam phase. During each steam phase, the temperature of the overheated steam, measured at the measuring point or with the measuring device 312 or 313, decreases. If this temperature decreases below a predetermined limit temperature TG2, the steam phase is preferably terminated and activated in the heating phase.

The reason for this is the process in reactor 1. If the steam temperature is too low, the yield of hydrogen is reduced. In the case shown in FIG. 4 (regenerator 21 in the steam phase), the steam phase is terminated before the time Δtd has elapsed if the temperature at measuring point 313 has fallen below the value TG2.

Further temperature measuring points, which are not shown here, can be arranged on the regenerators 20 and 21 to check the correct gas distribution and the combustion process.

In order to control or reduce the thermal stresses in the radial directions of the regenerators 20 and 21, a method and corresponding devices as described in patent DE 97 44 387 C1 or in patent application DE 10 2012 023 517 A1 are preferably used.

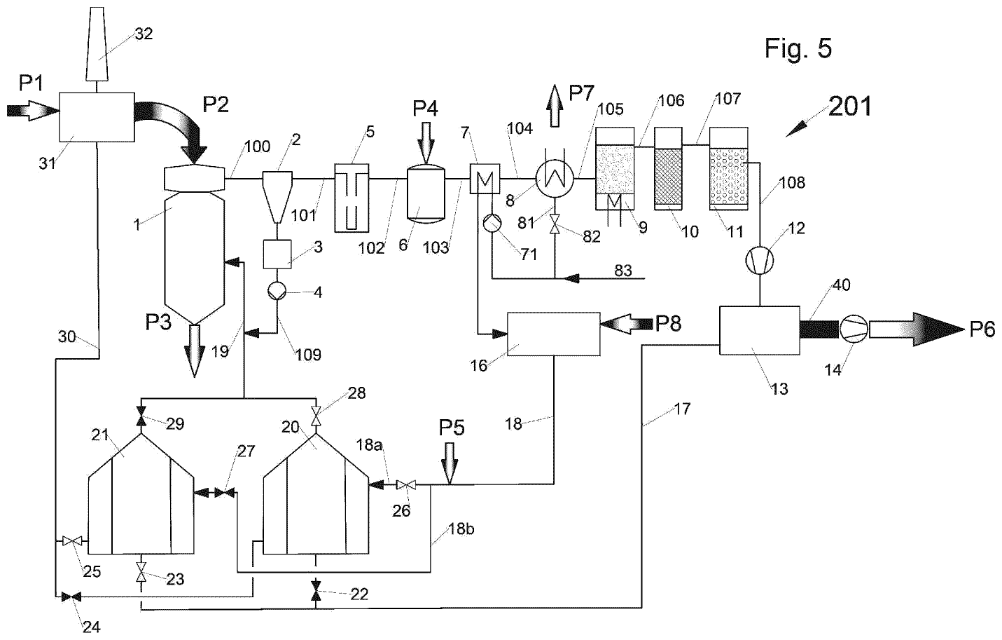

FIG. 5 shows an alternative to the apparatus 200 of FIG. 1. The energy required to generate steam in the boiler 16 does not come from the tail gas, but from another external energy source, along arrow P8. This can again be the same raw material as in FIG. 1, e.g. biomass.

But it can also be another raw material, e.g. industrial waste, waste gas, etc. . . . In this case, more tail gas will be available for steam overheating in the regenerators 20, 21. If this is not necessary, the excess tail gas is injected into the saturated steam line 18, along arrow P5. In this way, more H₂ is produced and the H₂ yield along arrow P7 per quantity of raw material P1 used will be specifically higher. This has a positive influence on the utilisation of the system 201 and, accordingly, on the economic efficiency. A further alternative is the use of an external steam source.

### Commissioning and Cleaning:

In order to prevent or at least minimise the deposition of the tars, a trace heating device is preferably provided on at least one of the lines 100, 101, 102, 103, preferably on several of these lines and preferably on all of these lines. A trace heating device is also preferably provided on the components cyclone 2 and dust filter 5 and preferably on the valves in the vicinity of the cracker 6, 61 to 64.

Preferably, at least one of these trace heating devices, preferably several of these trace heating devices and particularly preferably all of these trace heating devices are electrically operated heating devices.

As a trace heating device, a design with electric wires is the preferred solution, but there are also other solutions, e.g. steam heating or hot water heating.

The electrical trace heating device is preferably controlled very precisely because the wall temperature of the line must not be too low (intensive condensation of the tars), but also not too high (caking of tars).

Before commissioning the system, the lines and components mentioned are preferably preheated to a temperature between 50° C. and 80° C. During commissioning, the synthesis gas temperature increases and therefore the power of the trace heating must also increase so that the wall temperature always follows the synthesis gas temperature.

If the external insulation of the lines or components is sufficiently good, the power of the trace heating device(s) is preferably greatly reduced or even switched off (at least temporarily) when the nominal operating conditions are reached. The trace heating device is then preferably only used to regulate the wall temperature, ideally by a value in the range of the synthesis gas temperature and particularly preferably in a range of +5 K of the synthesis gas temperature.

Preferably, the lower part of reactor 1 is filled with lime, dolomite, old ash (if available) or similar material. In this case, regenerators 20 and 21 supply only slightly overheated water vapour, approx. 200° C. to 300° C., to preheat the empty (without biomass!) reactor 1, cyclone 2, particle filter 5 and cracker 6.

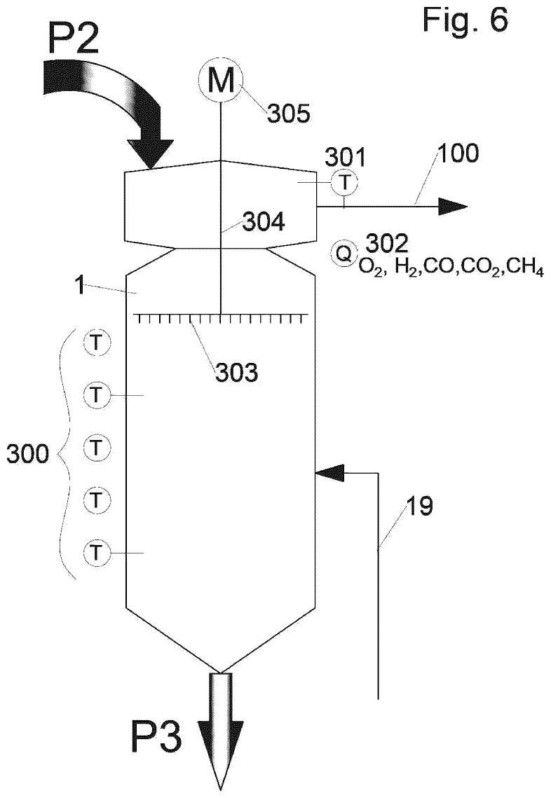

FIG. 6 shows the most important measuring points and components for the safety and control of the gasifier device or reactor 1. A plurality of temperature measuring points or temperature measuring devices 300 is provided on the side, which are arranged at different heights of the bed of fuel. There are preferably at least four such measuring points, preferably at least eight, and particularly preferably at least ten and preferably twelve.

In a preferred embodiment, these measuring points or measuring devices are not arranged one above the other, but around the reactor. In a normal working operation, the measured temperatures should drop from the bottom to the top. If this is not the case, it means that the bed is not evenly energised or that there are empty spots in the bed.

In such a case, the gasification device is controlled in order to change its working operation. In this way, the gasification agents and energy carriers can be increased through line 19 and/or additional quantities of fuel P2 can be introduced.

In order to achieve a constant capacity of the reactor 1, a further temperature measuring device or measuring point 301 is provided (directly) at the reactor outlet. If the temperature measured there is higher than a target temperature T1, this means that there is not enough fuel in the reactor. In this case, additional quantities can be filled in through P2. The temperature drops in this case and if a lower setpoint temperature T2 is reached, the further fuel supply is stopped until the upper setpoint temperature T1 is reached again.

A rotating rake 303 is used to evenly distribute the fuel introduced in order to avoid empty or unevenly filled areas in the bed. The rake is driven by a motor 305 by means of a shaft 304. The torque on this motor provides information about the fuel quantities in the reactor 1, which can be used as an alternative method of capacity control. If the torque is less than a predetermined value M1, this means that the rake is rotating empty and the fuel quantity is too low. By adding fuel through P2, the torque increases and as soon as a value M2 is reached, the fuel supply is stopped until the torque value M1 is reached again.

In a preferred method, the conveying capacity of the products to be gasified is therefore controlled and in particular regulated as a function of several control variables.

In a further preferred embodiment, a drive device is provided which allows the vertical position of the rake 304 to be changed. The vertical position of the rake 303 and/or the shaft 304 can be changed in particular depending on the fuel quality (composition, water content, lumpiness, etc.). This has an influence on the target temperatures T1 and T2 and on the torques M1 and M2.

The composition of the synthesis gas is preferably measured at the reactor outlet or at line 100, in particular immediately after the reactor (measuring point 302 in FIG. 6). This serves to change the input parameters in order to achieve a higher yield of hydrogen.

Preferably, the apparatus has a measuring device for determining the oxygen content of the synthesis gas.

In addition to the usual components of the synthesis gas (H₂, CO, CO₂, CH₄ . . . ), it is also preferable to measure the oxygen concentration (O₂). Oxygen can, for example, enter the reactor through the biomass lock and thus into the synthesis gas.

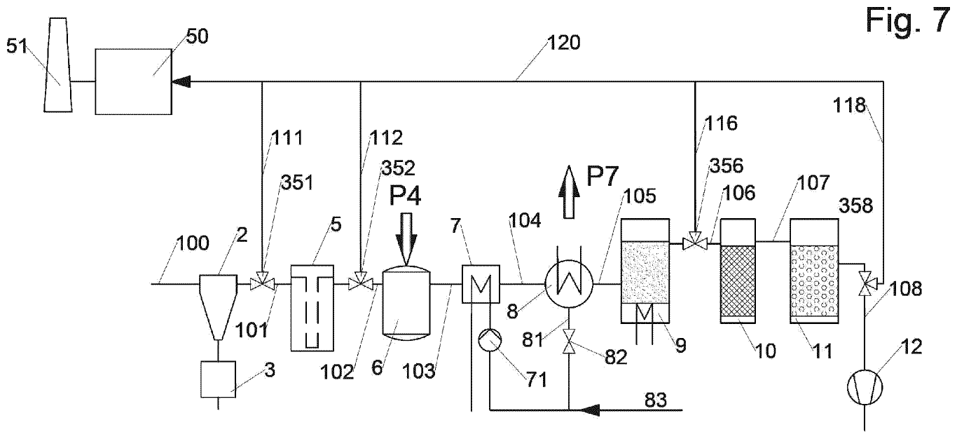

This is extremely undesirable because it produces oxyhydrogen (mixture of H₂+O₂), which can damage the system and injure personnel. For this reason, the system immediately goes into an EMERGENCY state if the oxygen concentration reaches a predetermined value. The supply of reactant through line 19 is stopped (in particular immediately) and nitrogen is preferably injected and/or the by-pass lines 111 to 118, shown in FIG. 7, are opened.

The system may only be put back into operation when the oxygen concentration falls significantly below the limit value. If such a situation occurs again, the system must be shut down until the cause has been found and rectified.

The exhaust gases, which may also contain some tars from previous operation, are preferably channelled into an afterburner chamber 50 (see FIG. 7).

The steam supply is then preferably stopped and the filling of reactor 1 is started. When reactor 1 is sufficiently filled with fuel, the water vapour supply is preferably started again so that the first quantities of synthesis gas are produced.

During commissioning, the entire system 200 is preferably not switched on immediately, but one part at a time. For this reason, at least two, preferably four or even more by-pass lines are preferably provided. FIG. 7 shows four such lines, 111, 112, 116 and 118, together with a collective line 120.

By-pass valves 351, 352, 356 and 358 are preferably used for this purpose. These valves are preferably designed as three-way valves (alternatively, two two-way valves with a coupled actuator can be used). At the beginning, by actuating the valve 351, the by-pass line 111 is opened so that the synthesis gas cannot flow further in the direction of particle filter 5.

If the temperature and operation of cyclone 2 are OK, the by-pass line 112 is opened by actuating the valve 352. Then the line 111 is closed, so that the entire quantity of synthesis gas flows through particle filter 5 and line 112. This mode of operation is continued until the last line 118 is opened by actuating the valve 358. Only when the temperatures, gas quality and the pressure of the synthesis gas are OK at this point, the by-pass line 118 is preferably closed and the gas flows through the PSA system 13 via the compressor 12. The production of pure hydrogen thus begins.

Via line 120, the low-quality synthesis gas from by-pass lines 111 to 118 reaches an afterburner chamber 50, where this gas, together with more or less tar residues, is afterburned and the clean exhaust gases are discharged into the atmosphere through chimney 51.

The afterburner chamber 50 can be integrated into the combustion chamber of the boiler 16 in order to utilise the heat generated for steam generation. During commissioning, an external fuel, preferably renewable fuel such as biomass, bio-diesel or bio-methane, is preferably used for saturated steam generation in boiler 16 and for steam overheating in regenerators 20 and 21. The external fuel is preferably not used until the production of the synthesis gas is fully operational.

### Cleaning

After an operating stop, the system is preferably cleaned and/or prepared for the next operating phase. Firstly, reactor 1 is taken out of operation, i.e. biomass is no longer fed in and/or steam is no longer fed in. Alternatively, lime, dolomite, old ash or similar material can be filled instead of biomass. All by-pass lines 111 to 118 are preferably open in this phase.

Then continue with a reduced steam supply, with ever lower steam temperature, until approx. 300° C. is reached.

When the biomass has been consumed or removed through the ash sluice, the cleaning of the system begins. Slightly superheated steam (200-300° C.) flows through reactor 1 and through lines 100, 101, 102, 103, through cyclone 2, particle filter 5 and the cracker 6 and removes any tars that may have been deposited.

If necessary, air can be added to the saturated steam and both can be overheated to 200° C. to 300° C. This allows the stubborn caking of tars in the lines to burn off. Preferably, the temperature is monitored, as additional heat is generated. At the end, it is preferable to stop the water vapour supply and allow the system to cool down.

Depending on the fuel quality, one or several system components can be omitted, such as the cyclone 2, the particle filter 5 or the cracker 6.

If a fuel with absolutely no small particles is used, which does not form any particles when reacting with water vapour, then the particle filter 5 can be dispensed with.

If you are batching a fuel that does not contain any volatile components, the use of Cracker 6 may be superfluous.

If you have a sulphur-free fuel, the ZnO filter 11 is no longer necessary.

All components of the system 200 are necessary to produce a very high quality of hydrogen, as required for the fuel cell, for example. If one wishes to feed the hydrogen produced into a natural gas pipeline, the quality requirements are not as high, and one or several components 9, 10 or 11, can be omitted. These components (9, 10, 11) can also be arranged in a different order to that shown.

The applicant reserves the right to claim all features disclosed in the application documents as being essential to the invention, provided that they are new, either individually or in combination, compared to the state of the art. It should also be noted that the individual figures also describe features which may be advantageous in themselves. The person skilled in the art immediately recognises that a certain feature described in a figure can also be advantageous without the adoption of further features from this figure. Furthermore, the person skilled in the art recognises that advantages can also result from a combination of several features shown in individual figures or in different figures.

1. A method for converting carbon-containing raw materials and in particular biomass into hydrogen, comprising the steps of:
gasification of the carbon-containing raw materials in a gasifier, wherein heated water vapour is introduced into the gasifier and used for gasification;
cleaning of the hydrogen-containing synthesis gas produced in the gasification, wherein the gasification is preferably an allothermal gasification and the heated water vapour is used both as gasification agent and as heat carrier for the gasification,
wherein
energy not used for the H₂ generation is at least partially reused for the generation and/or overheating of water vapour and/or a variable characteristic of the conversion process is measured by at least two different measuring devices and the method is controlled by a control device taking this characteristic variable into account.

2. The method according to claim 1,
wherein
chemical energy of the synthesis gas, in particular at an outlet of the gasifier, is higher than the chemical energy of the carbon-containing raw material and preferably at least 20% higher, preferably at least 30% higher, preferably at least 40% higher and particularly preferably at least 50% higher.

3. The method according to claim 1,
wherein
tar is separated from the synthesis gas and preferably at least a proportion of this tar is fed to the gasification process.

4. The method according to claim 1,
wherein
the synthesis gas is cooled in a first cooling step and thermal energy generated during this cooling is used to preheat the feed water for the boiler.

5. The method according to claim 1,
wherein
the synthesis gas is cooled in a further cooling step following the first cooling step, wherein preferably for this further cooling step a cooling device is used in which temperatures below 30°, preferably below 20°, below 0° C., below −5° C. prevail, wherein preferably a cryocooler is used for cooling, wherein this cryocooler preferably has at least two interacting regenerator devices.

6. The method according to claim 4,
wherein
the cooled synthesis gas is filtered, wherein a filter device is used for this purpose, in particular a carbon filter device and/or a zinc oxide filter and/or a doped carbon filter.

7. The method according to claim 1,
wherein
the purified and cooled hydrogen is compressed and, in particular, compressed at a pressure of at least 100 bar, preferably at least 200 bar, preferably at least 300 bar.

8. The method according to claim 1,
wherein
hydrogen is separated from other gases by a separation device and a PSA system is preferably used for this purpose and/or an exhaust gas from the separation device is used to generate and/or heat water vapour.

9. The method according to claim 1,
wherein
the carbonaceous raw materials are dried prior to their gasification and combustion gases from at least one regenerator are preferably used for this drying.

10. The method according to claim 1,
wherein
the synthesis gas is cleaned by a thermal cracker, wherein at least two interacting regenerator devices are preferably used for this purpose.

11. The method according to claim 1,
wherein
characteristic values of the synthesis gas are determined with a plurality of measuring devices and the conversion process is controlled on the basis of these values, wherein these values are preferably selected from a group of values consisting of a temperature value, a pressure value, a moisture value of the synthesis gas.

12. An apparatus for converting carbon-containing raw materials and in particular biomass into hydrogen, having a gasification device for gasifying the carbon-containing raw materials, having a supply device which introduces heated water vapour into the gasifier in order to use it for gasification, and having a cleaning device for cleaning the hydrogen-containing synthesis gas produced during the gasification, wherein the gasification is preferably an allothermal gasification and the heated water vapour is used both as a gasification agent and as a heat carrier for the gasification,
wherein
the apparatus has a recovery device in order to further use energy which is no longer usable for the H₂ generation for the generation and overheating of water vapour and/or the apparatus has at least two different measuring devices which measure a variable characteristic of the conversion process and a control device controls the apparatus taking this characteristic variable into account.

13. The method according to claim 1,
wherein
different process parameters are recorded with a plurality of measuring devices and/or sensor devices, wherein the recording preferably takes place over a longer period of time.

14. The method according to claim 1,
wherein
a temperature characteristic of the gasification process is measured and, in particular, this temperature is measured at at least two different positions of a gasification device.

15. The method according to claim 1,
wherein
the measured values and/or process parameters are recorded continuously and/or clocked and, in particular, are recorded with a time allocation, wherein preferably n-tuples are recorded from several measured values, in particular with a temporal assignment.

16. The method according to claim 1,
wherein
an evaluation device and/or processor device derives information from the recorded measured values and/or data which are characteristic of the operation of the apparatus or of the method.

17. The method according to claim 1,
wherein
the characteristic variable is selected from a group of variables which includes a temperature of the water vapour occurring during gasification, a temperature of the synthesis gas, a pressure of the synthesis gas, a torque of a drive device which conveys the biomass to the gasifier, a flow rate, a pH value of the carbonaceous material and the like.

18. The method according to claim 1,
wherein
the carbon-containing raw materials are fed to the gasification process by conveying device and preferably this conveying device is controlled and in particular regulated on the basis of at least one characteristic variable.

19. The method according to claim 1,
wherein
at least one parameter characteristic of a conveying device for conveying the carbonaceous raw materials is measured.

20. A method of operating an apparatus for converting carbon-containing raw materials and in particular biomass into hydrogen, wherein in a working operation of the apparatus the following steps are performed:
gasification of the carbon-containing raw materials in a gasifier, wherein heated water vapour is introduced into the gasifier and used for gasification; and
cleaning of the hydrogen-containing synthesis gas produced in the gasification, wherein the gasification is preferably an allothermal gasification and the heated water vapour is used both as a gasification agent and as a heat carrier for the gasification,
wherein
in a cleaning operation of the apparatus, cleaning of components of the apparatus and in particular of at least the gasifier is carried out, wherein these components are cleaned with a flowable cleaning medium and in particular with water vapour as part of this cleaning.

21. The method according to claim 20,
wherein,
for the purpose of cleaning, water vapour is heated to a predetermined temperature and the gasifier and connecting lines which discharge the synthesis gas from the gasifier are cleaned.

22. The method according to claim 20,
wherein,
a process variable characteristic of the working operation is measured at least at times and preferably during a working operation and a cleaning operation is initiated on the basis of this process variable and preferably the process variable is a pressure and, in particular, is a pressure of the synthesis gas.

23. The method according to claim 20,
wherein
further components of the apparatus are cleaned, wherein preferably these components are selected from a group of components which includes a valve, a pipeline, a heat exchanger, a cooler, and a filter device.

24. The method according to claim 20,
wherein
valves of the apparatus are switched at least intermittently during the cleaning operation in order to carry out cleaning of different components of the apparatus.

25. The method according to claim 20,
wherein
a temperature of the cleaning medium is measured at least intermittently during the cleaning operation.

26. The method according to claim 20,
wherein
components of the apparatus are cleaned manually.

27. The method according to claim 20,
wherein
a consumption of cleaning agent is determined.

28. The method according to claim 20,
wherein,
after a cleaning operation, a resumption operation is carried out in order to transfer the apparatus to the working operation and, preferably, the apparatus is operated with different process parameters during this resumption operation than during the working operation.

29. A apparatus for converting carbon-containing raw materials and in particular biomass into hydrogen, having a gasification device for gasifying the carbon-containing raw materials, having a supply device which introduces heated water vapour into the gasifier in order to use it for gasification, and having a cleaning device for cleaning the hydrogen-containing synthesis gas produced during the gasification, wherein the gasification is preferably an allothermal gasification and preferably the heated water vapour is used both as gasification agent and as heat carrier for the gasification,
wherein
the apparatus is configured to enable a cleaning operation for cleaning components of the apparatus and in particular at least of the gasifier, wherein in the course of this cleaning operation these components can be cleaned with a flowable cleaning medium and in particular with water vapor.
